(19) United States
(12) Patent Application Publication
(10) Pub. No.: US 2026/0046223 A1
(43) Pub. Date: Feb. 12, 2026

(54) CYCLE TIME DETERMINATION IN A PROCESS CONTROL SYSTEM

(71) Applicant: ABB Schweiz AG, Baden (CH)

(72) Inventors: Zhibo Pang, Västerås (SE); Koushik Bhimavarapu, Malmö (SE)

(21) Appl. No.: 19/100,158

(22) PCT Filed: Aug. 15, 2022
(86) PCT No.: PCT/EP2022/072784

§ 371 Date: Jan. 31, 2025

(51) Int. Cl. H04L 41/5006; G05B 15/02; H04L 67/12

(52) U.S. Cl. CPC H04L 41/5006; G05B 15/02; H04L 67/12

(57) ABSTRACT

A process control system including an automation device, a process control function, a cycle time determining function and hardware implementing the process control function and cycle time determining function, where the process control function controls the automation device in a process control loop via a first wireless communication network and the cycle time determining function obtains a first mapping of cycle time of the process control loop to quality of service of the first wireless communication network and control performance of the process control loop, analyses the first mapping and determines a cycle time to be used in the first wireless communication network based on the analysis.

### TECHNICAL FIELD

The present disclosure relates to a cycle time determining device, method, computer program and computer program product for determining a cycle time to be used in a process control system as well as to such a process control system.

### BACKGROUND

Using low latency and high reliability wireless communications, such as 5G, WiFi6, and beyond, to replace the wired networks in control systems of e.g., motors, drives, robots, and processes will enable unprecedented flexibility of deployment and reduce costs. As a long-term vision, system developers of such wireless networked control system (WNCS) expect to keep the control functions agnostic to the communication networks, i.e., no matter wired or wireless network, the same configurations of the control function can be used. However, this expectation is hard to meet by the wireless technologies in short-term, even by the new generation of cellular networks like 5G and WLAN (wireless local area network) like the WiFi6. To get the benefits of wireless communications as early as possible, a more realistic strategy is to tune the configurations of the control application according to the achievable quality of service (QoS) of the wireless network. One configuration that can be tuned is the cycle time of the control loop.

US 2021/0022172 discloses the obtaining of network flow configuration or a QoS (Quality of Service) flow, where a QoS flow comprises a cycle time requirement and an association between up-link and down-link message transmissions. The QoS flow is then used in the allocation of resources in the wireless network.

Generally speaking, if the communication network is perfect, a shorter cycle time can achieve better control performance as the control function can get more data from sensors and take actions more frequently through the actuators until the maximum speed of the sensors, actuators, or controller is reached. Therefore, application developers typically choose the shortest cycle time that can be supported by the controller, sensors, and actuators. In existing solution of WNCS, such as in U.S. Pat. No. 9,743,398, the cycle time is determined by the process control function solely. Then the cycle time is given to a scheduling algorithm of the wireless communication network without considering the capability of the wireless communication network, and the wireless communication network will do its best to meet the cycle time.

This is suboptimal for two reasons: 1) The wireless communication networks have limited QoS and the QoS typically drops quickly when the cycle time is shorter than certain threshold, even though the scheduling algorithm of the wireless communication network can work through (i.e., the network is overloaded), which results in worse control performance, 2) this method is hard to implement to the latest wireless networks, such as the 5G, because the scheduling algorithm of the wireless communication network is not accessible to the control application.

In short, a novel solution is needed for determining the cycle time.

### SUMMARY

One objective of the invention is therefore to provide an improved determination of cycle time.

According to a first aspect there is presented a cycle time determining device for determining a cycle time to be used in a process control system, the process control system comprising an automation device, a process control function, and hardware implementing the process control function, where the process control function controls the automation device in a process control loop via a first wireless communication network;
the cycle time determining device comprising a cycle time determining function and hardware implementing the cycle time determining function, the cycle time determining function being configured to:
obtain a first mapping of cycle time of the process control loop to quality of service of the first wireless communication network and control performance of the process control loop;
analyse the first mapping between cycle time, quality of service and control performance; and
determine a cycle time to be used in the first wireless communication network based on the analysis.

According to a second aspect, there is provided a method for determining a cycle time to be used in a process control system, the process control system comprising
a process control function and hardware implementing the process control function, where the process control function controls an automation device in a process control loop via a first wireless communication network;
the method comprising:
obtaining a first mapping of cycle time of the process control loop to quality of service of the first wireless communication network and control performance of the process control loop;
analysing the first mapping between cycle time, quality of service and control performance; and
determining a cycle time to be used in the first wireless communication network based on the analysis.

According to a third aspect, there is provided a process control system comprising:
an automation device;
a process control function and hardware implementing the process control function, where the process control function controls the automation device in a process control loop via a first wireless communication network; and
a cycle time determining function and hardware implementing the cycle time determining function, the cycle time determining function being configured to obtain a first mapping of cycle time of the process control loop to quality of service of the first wireless communication network and control performance of the process control loop, analyse the first mapping between cycle time, quality of service and control performance and determine a cycle time to be used in the first wireless communication network based on the analysis.

According to a fourth aspect, there is provided a computer program for determining a cycle time to be used in a process control system;
the process control system comprising a process control function and hardware implementing the process control function, where the process control function controls an automation device in a process control loop via a first wireless communication network, the computer program comprising computer program code which when run by a processor implements a cycle time determining function configured to:
obtain a first mapping of cycle time of the process control loop to quality of service of the first wireless communication network and control performance of the process control loop;
analyse the first mapping between cycle time, quality of service and control performance; and
determine a cycle time to be used in the first wireless communication network based on the analysis.

According to a fifth aspect, there is provided a computer program product for determining a cycle time to be used in a process control system, the computer program product comprising a data carrier with the computer program code according to the fourth aspect.

The process control function and hardware implementing the process control function may be provided in an automation function environment. Also, the cycle time determining function and the hardware implementing the cycle time determining function may be provided in the automation function environment. The automation function environment may additionally comprise a hardware assigning unit configured to assign hardware to the process control function and/or the cycle time determining function.

As an alternative it is possible that the hardware implementing the process control function and/or the hardware implementing the cycle time determining function is hardware dedicated to the function.

The control performance may be based on a performance of the automation device. It may be expressed through the quality of a performed control activity on or by the first automation device. For instance, the control performance may be expressed as an error in performing the control activity using the automation device. If for instance the automation device comprises a motor, the control performance may be provided as an error in the motor speed, such as a root mean square error of the motor speed. It should be realized that the control performance can be indicated by other parameters linked to the control, such as stability, convergence speed and energy consumption.

Alternatively the control performance may be expressed through the performance in communicating between the process control function and the automation device, such as expressed through average latency, reliability, packet loss rate, etc.

The quality of service may be provided through the availability of the first wireless communication network.

The determined cycle time may be a cycle time for which the combination of cycle time, quality of service and control performance fulfils or meets at least one control loop criterion. A control loop criterion may be that the combination is optimal, i.e. the selecting of the best combination of cycle time, QoS and control performance. The determined cycle time may thus be a cycle time for which the combination of cycle time, quality of service and control performance is optimal. Additionally or instead, the determined cycle time may be a cycle time for which each of the cycle time, quality of service and control performance is as close as possible to a corresponding ideal or optimal value. The determined cycle time may be an acceptable cycle time for which both the quality of service and the control performance are also acceptable. Put differently the selected cycle time may be the cycle time for which each of the cycle time, quality of service and control performance deviates from a corresponding ideal or optimal value by less than a corresponding maximum deviation. If the quality of service is provided as an availability of the first wireless communication network and the control performance as an error in the control of the automation device, the determined cycle time may be the lowest cycle time for which the availability stays above an availability threshold and for which the control error is kept below a control error threshold.

According to one variation of the first aspect, the cycle time determining function is further configured to obtain at least one further mapping between cycle time, control performance and quality of service of at least one other communication network and the obtaining of the first mapping may additionally comprise determining the first mapping based on the at least one further mapping.

According to a corresponding variation of the second aspect, the method may further comprise obtaining at least one further mapping between cycle time, control performance and quality of service of at least one other communication network and the obtaining of the first mapping may comprise determining the first mapping based on the at least one further mapping.

The at least one further mapping may comprise empirical data of at least one other communication network, such as empirical data concerning the performance of the control loop with different used cycle times and used qualities of service in the at least one other communication network.

It is additionally possible that the cycle time determining function, when obtaining the first mapping, is further configured to obtain a relationship between cycle time and quality of service of the first wireless communication network and add estimates of control performance to the relationship for forming the first mapping, where the estimates of control performance are based on the mapping of control performance to the cycle time and quality of service in the at least one further mapping.

It is correspondingly possible that the determining of the first mapping performed in the method comprises obtaining a relationship between cycle time and quality of service of the first wireless communication network and adding estimates of control performance to the relationship for forming the first mapping, where the estimates of control performance have been estimated based on the mapping of control performance to the cycle time and quality of service in the at least one further mapping.

Thereby the first aspect may additionally involve the cycle time determining function being configured to estimate the control performance in the first wireless communication network based on the mapping of control performance to cycle time and quality of service in the at least one further mapping.

Consequently, the second aspect may involve estimating the control performance in the first wireless communication network based on the mapping of control performance to cycle time and quality of service in the at least one further mapping.

It is additionally possible that the at least one further mapping comprises a group of further mappings, where the mappings are mappings of cycle time and control performance to quality of service of different types of communication networks, such as different types of wireless communication networks and possibly also one or more different types of wired communication networks.

The estimates of the control performance may be based on a statistical operation of the control performances linked to the cycle times and QoS of the group of further mappings, such as determining a median or average value of the control performances corresponding to different cycle time. It is also possible that the worst case is removed. It is for instance possible to omit a further mapping that is concerned with a wired communication network. It is also possible to omit a further mapping based on a lack of resemblance to the relationship. As another option, it is possible that the control performance of the same type of communication network is estimated to be the control performance of the first wireless communication network. As another possibility it is possible to take the control performances of the further mapping having a relationship between QoS and cycle time that most resembles the relationship between QoS and cycle time for which control performance is to be estimated.

According to another variation of the first aspect, the cycle time determining function may be further configured to negotiate a quality of service with a network management system of the first wireless communication network, which negotiated quality of service corresponds to the determined cycle time.

According to a corresponding variation of the second aspect, the method may further comprise negotiating a quality of service with a network management system of the first wireless communication network, which negotiated quality of service corresponds to the determined cycle time.

The hardware assigning unit may be implemented using hardware in the automation function environment, such as dedicated hardware in the automation function environment.

The automation device may employ a wireless interface to the first wireless communication network.

The process control system may comprise a network interface to the first wireless communication network for the hardware implementing the process control function, which network interface may be of a first type that is an interface to a backbone network of the first wireless communication network or of a second type that is an air interface to the first wireless communication network, such as an air interface to a base station of the first wireless communication network.

The automation function environment may be a virtual cloud-based automation function environment where the process control function is realized as a virtual controller and the hardware assigning unit implements a virtualization layer, while the automation device may be a real automation device. Alternatively, the automation function environment may be provided in an edge node, from which the process control function communicates with the automation device.

The first wireless communication network may be a part of the process control system or external to the process control system.

The automation device may be any type of device that is used in control system such as a robot, a relay, a valve, a power switch, a conveyer belt, a motor, a drive, an I/O module, a sensor or an actuator.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a diagram schematically illustrating a first embodiment of a process control system comprising a cycle time determining device, automation devices and a controller controlling the automation devices via a first wireless communication network,

FIG. 2 schematically shows a first realization of the cycle time determining device,

FIG. 3 schematically shows a first realization of the controller,

FIG. 4 schematically shows a second embodiment of the process control system,

FIG. 5 schematically shows a third embodiment of the process control system implemented using an automation function environment,

FIG. 6 schematically shows computational resources used in the automation function environment,

FIG. 7 shows a flowchart schematically illustrating a number of method steps in a first version of a method of determining the cycle time of a process control loop in the process control system,

FIG. 8 is a flow chart illustrating a number of method steps in a second version of the method of determining the cycle time of a process control loop in the process control system, and

FIG. 9 schematically shows curves of control performance and cycle time for a first mapping as well as for a first, second, third and fourth further mapping of control performance, cycle time and quality of service.

### DETAILED DESCRIPTION

Aspects of the present disclosure will now be described more fully hereinafter with reference to the accompanying drawings, in which certain embodiments are shown.

These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

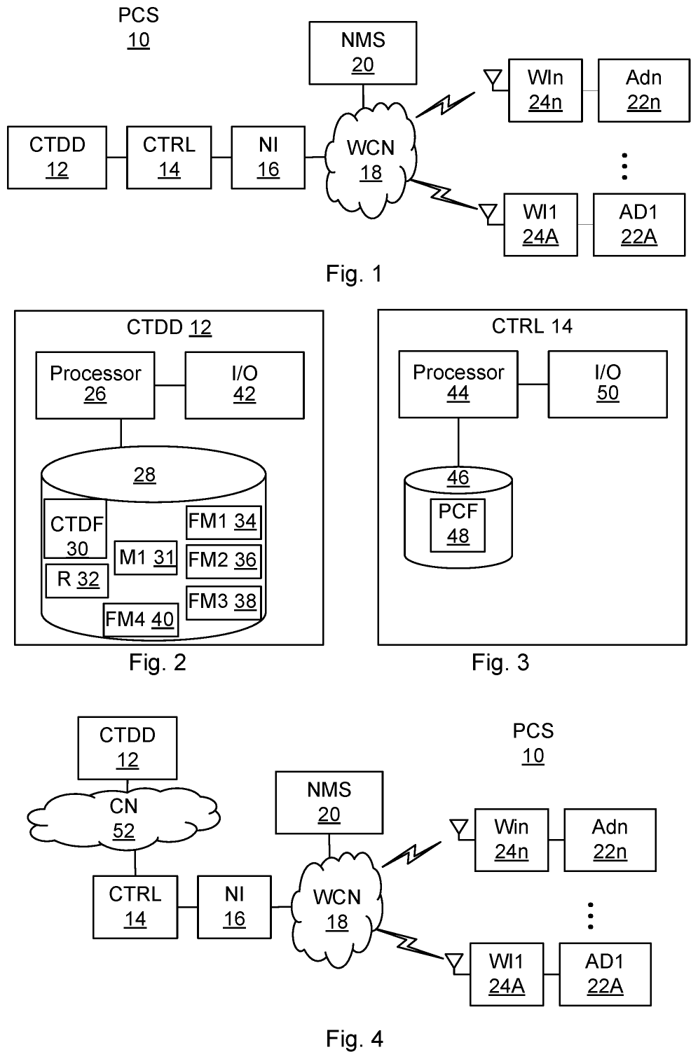

FIG. 1 is a diagram schematically illustrating a first embodiment of a process control system PCS 10, which process control system 10 comprises a controller CTRL 14 controlling a group of automation devices 22A-22n via a first communication network 18, which first communication network in this case is a first wireless communication network WCN 18, which may be an external wireless network, such as a public wireless network, or an internal wireless network, i.e. a wireless network that is a part of the process control system 10. Furthermore, the first wireless communication network 18 may be a deterministic network, i.e. a network where the delay or latency is limited through the network guaranteeing that messages are being transferred in a set time period. In this example the group of automation devices comprises n automation devices. There is thus a first automation device AD1 22A and an nth automation device ADn 22n. Furthermore, each automation device is connected to a corresponding wireless interface in order to communicate with the controller 14. The first automation device 22A is thus connected to a first wireless or air interface WI1 24A and the nth automation device is connected to an nth wireless or air interface WIn 24n, which wireless interfaces 24A, 24n may be realized using radio circuits and antennas in order to enable wireless communication with base stations of the first wireless communication network 18. Also, the controller 14 is connected to a network interface NI 16 for connecting to the wireless communication network 18, which network interface may be a wired interface to a backbone network of the wireless communication network 18 or a wireless interface, where the wireless interface may be realized through the combination of radio circuit and antenna, while the wired interface may be realized as an Ethernet interface.

There is also a cycle time determining device CTDD 12 connected to the controller 14 as well as a network management system NMS 20 that manages the first wireless communication network 18.

FIG. 2 schematically shows a first variation of the cycle time determining device CTDD 12. It comprises a first processor 26 connected to a first memory 28 with computer instructions implement in a cycle time determining function CTDF 30. The computer instructions may be computer program code of a computer program, where the computer program code implements the cycle time determining function 30 when being run by the first processor 26. The combination of first processor 26 and first memory 28 is one realization of hardware used to implement the cycle time determining function 30. The hardware implementing the cycle time determining function 30 is in this case hardware that is dedicated to this function. The memory 28 may also be considered to be a data carrier with the computer program code used to implement the cycle time determining function 30. In this case the data carrier with computer program code implementing the cycle time determining function 30 may also be considered to form a computer program product.

In the first memory 28 there is also a first mapping M1 31 between cycle time, control performance and quality of service (QoS), where the cycle times and control performances are the cycle times and control performances of a process control loop in the process control system 10 when the first wireless communication network 18 is employed and QoS is QoS of the first wireless communication network 18. There is also a relationship R 32 between the above-mentioned cycle time and QoS, i.e. of cycle time of a control loop of the process control system when used in the first wireless communication network 18 and QoS of the first wireless communication network 18. There is also a first further mapping FM1 34, a second further mapping FM2 36, a third further mapping FM3 38 and a fourth further mapping FM4 40, where each further mapping is a mapping between cycle time and control performance of the process control loop to QoS for different types of communication networks. The cycle time determining device 12 also comprises a first Input/Output interface I/O 42 for communicating with other devices such as the controller 14. The first I/O interface 42 may also be realized as an Ethernet interface.

FIG. 3 schematically shows a first variation of the controller CTRL 14. It comprises a second processor 44 connected to a second memory 46 with computer instructions implementing a process control function PCF 48. The combination of second processor 44 and second memory 46 is one realization of hardware used to implement the process control function 48. The hardware implementing the process control function 48 is in this case hardware dedicated to this function. The controller 14 also comprises a second Input/Output interface I/O 50 for communicating with other devices such as the cycle time determining device 12. The second I/O interface 50 may also be an Ethernet interface. If the controller 14 is connected to a backbone network of the first wireless communication network 18, the second I/O interface 50 may be combined with the network interface 16.

FIG. 4 shows a second embodiment of the process control system 10. The controller 14 is in this case connected to the first wireless communication network 18 via the network interface 16 and communicates with the automation devices 22A, 22n in the same way as in the first embodiment, where again there is a network management system 20 managing the first wireless communication network 18.

There is again a cycle time determining device 12, which in this second embodiment is connected to the controller 14 via a computer network CN 52, which computer network 52 may be a wired computer network. The computer network 52 may be an external computer network or an internal computer network, i.e. a network that is a part of the process control system 10.

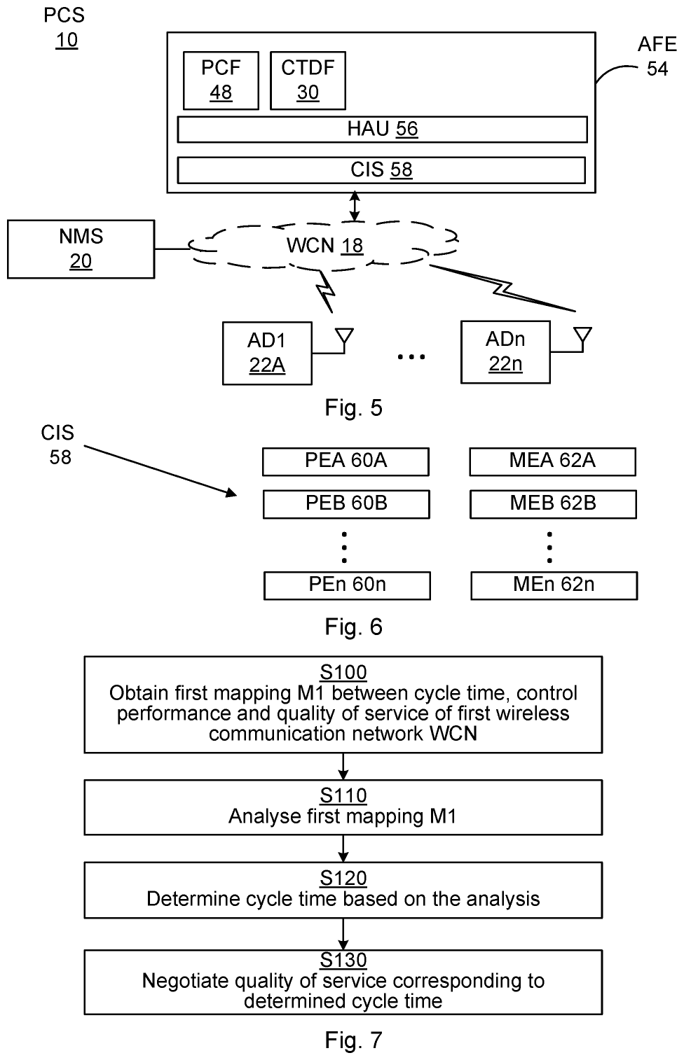

FIG. 5 shows a third embodiment of the process control system 10. In this third embodiment the process control function PCF 48, the cycle time determining function 30 as well as the hardware implementing the process control function and the cycle time determining function are provided in an automation function environment AFE 54, where the automation function environment 54 is in contact with the automation devices 22A, 22n via the first wireless communication network WCN 18. The automation function environment 54 may be connected to a backbone network of the first wireless communication network 18 or it may have a wireless connection to the first wireless communication network 18 using the previously mentioned network interface, which has here been omitted for simplifying the figure.

The automation function environment 54 comprises a computing infrastructure CIS 58 and a hardware assigning unit HAU 56, which is configured to assign hardware to the process control function 48 and possibly also to the cycle time determining function 30. The automation function environment 54 may as an example be a virtual cloud-based automation function environment, while the automation devices may be real automation devices. In this case the computing infrastructure CIS 58 may be a cloud computing infrastructure and the hardware assigning unit HAU 56 may be a virtualization layer for virtualizing cloud functionality.

As can be seen in FIG. 6, the computing infrastructure CIS 58 comprises a number of hardware resources. As an example, it comprises a first processing entity PEA 60A, a second processing entity PEB 60B and an nth processing entity PEn 60n as well as a first memory entity MEA 62A, a second memory entity MEB 62B and an nth memory entity MEn 62n. The hardware resources may thus comprise both processing and memory resources, such as processing blades and memory blades.

The process control function 48 may be realized as a virtual controller implemented using the computing infrastructure 58 based on a mapping made by the hardware assigning unit 56 to hardware of the computing infrastructure 58. The process control function 48 may be assigned to any of the hardware resources. As an example the process control function 48 may be assigned to the first processing entity 60A and the first memory entity 62A. The process control function together with the assigned hardware then forms a controller that controls the first and possibly also the nth automation device 22A, 22n. It is also possible that the cycle time determining function 30 in the same way is assigned to processing and memory resources in the automation function environment. The cycle time determining function 30 may as an example be assigned to the second processing entity 60B and the second memory entity 62B by the hardware assigning unit 56. As an alternative the cycle time determining function 30 may be realized using dedicated hardware in the automation function environment 54. The cycle time determining function 30 together with the hardware then forms the cycle time determining device. Also, the hardware assigning unit 56 may be realized using dedicated hardware in the automation function environment 54.

Alternatively, the automation function environment 54, the process control function 48 and the cycle time determining function 30 may be provided in an edge node communicating with the automation devices 22A, 22n.

The process control function 48 may control one or more automation devices, such as the first automation device 22A. As an example, the process control function 48 controls the first automation device 22A in a process control loop, e.g. in a loop that actuates the first automation device 22A based on one or more sensor measurements.

In operation the process control function 48 has been assigned hardware resource 60A, 62A. The process control function 48 is thus being run in a virtual machine, for instance as a virtual controller, on the assigned hardware 60A, 62A and then controls the first automation device 22A in the process control loop via the first wireless communication network 18. In this control a control cycle with a cycle time is used and the first wireless communication network provides a QoS.

In the automation device environment 54, the traditional hardware controllers in the field are removed. Instead, control logic is executed by automation functions, e.g. soft controllers, hosted by processing and memory hardware in the computing infrastructure 58, which can be realized by the ABB Ability, GE Predix, Siemens MindSphere, Microsoft Azure, Amazon Web Services, Alibaba Cloud, Huawei Mobile Cloud, etc. The control logic of the automation functions can be programmed in the PLC-specific languages such as IEC61131-3 and IEC61499, or generic programming languages such as C/C++. The computing infrastructure 58 can also be shared with other applications. ‘The process control function 48 is thus not performed by any hardware controller close to the first automation device 22A but by a soft controller implemented through the hardware resources assigned by the hardware assigning unit 56. The process control function 48 may thereby be hardware agnostic, i.e., it may be realized in the virtualized computing infrastructure 58 over the hardware assigning unit 56, such as with Docker containers and/or virtual machines of Linux, Windows, VxWorks, etc.

The cycle time determining device may be a part of an integrated development environment in which the process control function 48 is developed. The controller 14 and automation devices 22A, 22n are connected over the first wireless communication network 18 to transmit sensing data, control data, and device management data through their interfaces 16, 24A, 24n. The first wireless communication network 18 is managed by the network management system 20 and the necessary network information is accessible by the controller 14 and automation devices 22A, 22n. The first wireless communication network 18 can be implemented based on standardized technologies such as WirelessHART, ISA100, WIA-PA, WIA-FA, WiFi6, 5G, or beyond, or proprietary technologies such as EchoRing.

As an embodiment shown in FIG. 4, the integrated development environment with the cycle time determining device 12 and the controller 14 can be connected during the development phase through the computer network 52 (internet or intranet). As another embodiment, the first wireless communication network 18 is used not only for automation traffics but may also be used for Information Technology (IT) traffic, which makes it into a so-called Converged IT (information technology) and OT (operation technology) Network, and it can be implemented based on technologies such as TSN (time sensitive networking) over WiFi6, 5G or beyond. As was mentioned earlier, the cycle time determining function and process control function can be implemented as software hosted in virtualized cloud and/or edge computing environment such as the OpenStack, Microsoft Azure, Amazon Web Service, Huawei Cloud, Alibaba Cloud, etc.

The cycle time is the time for carrying out a control activity of a control loop based on obtained sensor measurements. Furthermore, the operation of the control loop has a control performance, which may be indicated through a performance measure, which may be linked to the operation of the automation device. The control performance may also be influenced by the first wireless communication network. Moreover, the first wireless communication network may have a QoS that can be varied. It is typically of interest to have as low a cycle time as possible. However, this selection should not be at the expense of the control performance and the quality of service. There is therefore a need for determining the cycle time while at the same time considering the control performance and QoS.

There may exist a first mapping M1 31 of cycle time of the process control loop to quality of service of the first wireless communication network and control performance of the process control loop. The first mapping 31 may thus be a mapping between cycle time of the process control loop, QoS of the first wireless communication network 18 and control performance for the use of the control loop in the first wireless communication network 18, where the first mapping lays out the dependency of the cycle time of QoS and of control performance, i.e. how the cycle time varies based on variations in QoS and control performance. The cycle time is the time within which the control loop is finished. The control performance may in turn be based on a performance of a control activity performed in the control loop involving the first automation device 22A. It may be expressed through the quality of a performed control activity on or by the first automation device 22A. For instance, the control performance may be expressed as an error in the first automation device 22A in performing the control activity. If for instance the first automation device 22A comprises a motor, the control performance may be provided as an error in the motor speed, such as a relative root mean square error of the motor speed. QoS may in turn be provided through the availability of the first wireless communication network 18.

The first mapping 31 may have been obtained in a number of ways. It may have been obtained through simulations or as off-line and on-line statistics obtained by the controller 14 and first automation device 22A with the assistance of the network management system 20. It may also be determined based on empirical data from known communication networks, which communication networks may be different types of wireless and/or wired communication networks, such mobile communication, WiFi and Ethernet networks. The first mapping 31 may be provided as a static configuration file, as a design library or as a look-up table.

How this first mapping 31 may be used will now be described with reference being made also to FIG. 7, which shows a flow chart of a number of method steps in a method of determining a cycle time of a process control loop for the first automation device 22A.

The cycle time is thus a cycle time for the controller 14 to control the first automation device 22A in a control loop via the first wireless communication network 18. In order to determine this cycle time, the cycle time determining function 30 obtains the first mapping 31 of cycle time of the process control loop to QoS of the first wireless communication network 18 and control performance of the process control loop, S100, for instance from a memory in which the first mapping 31 is stored. The memory may be the first memory 28 in the cycle time determining device 12 according to the first and the second embodiments or a dedicated memory resource in the automation function environment 54 according to the third embodiment. The QoS may as an example be expressed as the availability of the first wireless communication network, while the control performance may be expressed through the quality of a performed control activity using the first automation device 22A. If the first automation device 22A comprises a motor, then the control performance may as an example be a relative root mean square error of the motor speed error.

The cycle time determining function 30 then analyses the first mapping M1 31 between cycle time, quality of service and control performance, S110, which analysis may involve analysing how the cycle time varies for variations of QoS and control performance. The cycle time determining function 30 then determines a cycle time to be used in the first wireless communication network 18 based on the analysis, S120, which may be an acceptable cycle time for which both QoS and control performance are also acceptable. The determined cycle time may be the cycle time for which the combination of cycle time, QoS and control performance meets at least one control loop criterion. The criterion could be that each of the cycle time, QoS and control performance is as close as possible to a corresponding ideal or optimal value. Put differently the selected cycle time may be the cycle time for which each of the cycle time, QoS and control performance deviates from a corresponding ideal or optimal value by less than a corresponding maximum deviation. It may involve the lowest cycle time for which the availability stays above an availability threshold and for which a motor speed error is kept below a motor speed error threshold. There may also be an optimisation, i.e. the selecting of the best combination of cycle time, Qos and control performance based on one or more optimisation criteria.

The determined cycle time may then be applied in the process control function 48. It is also possible that the cycle time determining function 30 negotiates a QoS with the network management system 20, which negotiated QoS corresponds to the determined cycle time, S130, for instance through negotiating a service level agreement (SLA) that provides the QoS corresponding to the determined cycle time.

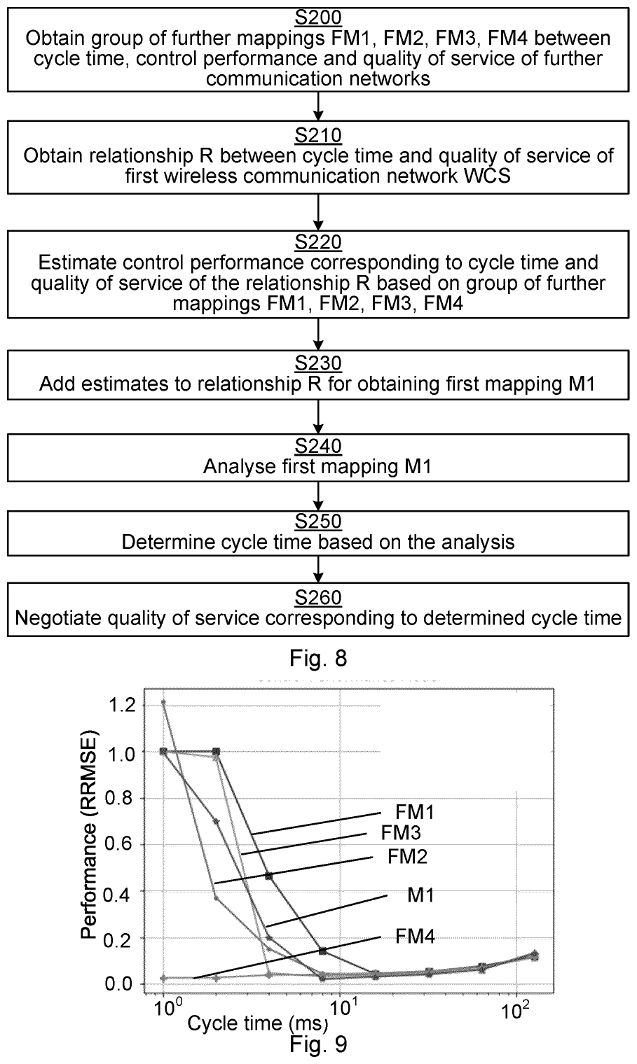

Another way of determining the cycle time will now be described with reference being made to FIG. 8, which shows a flow chart of second variation of the method of determining the cycle time, which is also being performed by the cycle time determining function 30.

The method starts by the cycle time determining function 30 obtaining at least one further mapping between cycle time, control performance and QoS of at least one other communication network, i.e. of at least one communication network that is different from or is not the first wireless communication network 18. In this example it involves the cycle time determining function 30 obtaining a group of further mappings 34, 36, 38, 40, where the mappings are mappings of cycle time and control performance to QoS of different types of communication networks, S200. Each of these mappings may be a mapping of empirical data of the at least one other communication network, such as empirical data concerning the performance of the control loop with different used cycle times and used qualities of service in the group of communication networks. The group of communication networks may comprise different types of wireless communication networks and possibly also one or more different types of wired communication networks, such as mobile communication, WiFi and Ethernet networks. It is for instance possible that the communication network of the first further mapping 34 is a 1-hop 5G network, that the communication network of the second further mapping 36 is a 1-hop WiFi6 network, that the network of the third further mapping 38 is a 1-hop hybrid 5G and WiFi6 network and the network of the fourth further mapping 40 is the mapping of an ideal wired Ethernet network. Each further mapping may have been obtained through simulations or as off-line and on-line statistics obtained by control of an automation device via the corresponding communication network with the assistance of an associated network management system. The further mappings 34, 36, 38, 40 may be obtained from one or more memories in which the mappings are stored, such as the first memory 28 in the cycle time determining device 12 according to the first and the second embodiments or a dedicated memory resource in the automation function environment 54 according to the third embodiment. QoS may again be the availability of the corresponding communication network and the control performance may be an error of a control command such as a motor speed error like a relative root mean square error of the motor speed.

The cycle time determining function 30 may obtain the further mappings 34, 36, 38, 40 as one or more static configuration files or as a design library. As an example given in table I below, the further mappings may be provided together in a table. Again, QoS reflects the availability of the communication networks and the cycle time may be expressed in ms.

TABLE I

| | | Control Performance | |
|---|---|---|---|
| Cycle Time | QoS | (Relative Root Mean Square | |
| (ms) | (Availability) | Error of Motor Speed) | Mapping |
| 1 | 0 | 1 | FM1 |
| 1 | 0.0001 | 1.213203538 | FM2 |
| 1 | 0 | 1 | FM3 |
| 1 | 1 | 0.02521583 | FM4 |
| 2 | 0 | 1 | FM1 |
| 2 | 0.05 | 1 | FM2 |
| 2 | 0.001 | 1 | FM3 |
| 2 | 1 | 0.02621991 | FM4 |
| 4 | 0.1 | 0.465117099 | FM1 |
| 4 | 0.98 | 0.14998171 | FM2 |
| 4 | 0.48 | 1 | FM3 |
| 4 | 1 | 0.037718274 | FM4 |
| 8 | 0.15 | 0.141147638 | FM1 |
| 8 | 0.9997 | 0.044157661 | FM2 |
| 8 | 0.9993 | 0.043240214 | FM3 |
| 8 | 1 | 0.039668335 | FM4 |
| 16 | 0.95 | 0.042060137 | FM1 |
| 16 | 0.99992 | 0.036541703 | FM2 |
| 16 | 0.99995 | 0.549433993 | FM3 |
| 16 | 1 | 0.044785876 | FM4 |
| 32 | 0.9991 | 0.051963053 | FM1 |
| 32 | 0.999992 | 0.048662681 | FM2 |
| 32 | 1 | 0.059589409 | FM3 |
| 32 | 1 | 0.054342464 | FM4 |
| 64 | 0.99995 | 0.076014188 | FM1 |
| 64 | 0.999995 | 0.061154794 | FM2 |
| 64 | 1 | 0.080575228 | FM3 |
| 64 | 1 | 0.071512358 | FM4 |
| 128 | 0.999992 | 0.116129881 | FM1 |
| 128 | 0.999999 | 0.132302704 | FM2 |
| 128 | 1 | 0.143909384 | FM3 |
| 128 | 1 | 0.113409443 | FM4 |

In this case, the obtaining of the first mapping 31 comprises determining the first mapping 31 based on the at least one further mapping. This may be done based on the relationship 32 between cycle time and QoS for the first wireless communication network 18 and the group of further mappings 34, 36, 38, 40. For this reason, the cycle time determining function may obtain the relationship 32 between cycle time and QoS for the first wireless communication network 18, S210, which relationship 32 may be provided as a function, a table or a configuration file. As an example the relationship 32 may be provided as the table II below, where the cycle time may be in ms and the QoS as the availability of the first wireless communication network 18.

TABLE II

| Cycle Time (ms) | QoS (Availability) |
|---|---|
| 1 | 0 |
| 2 | 0.1 |
| 4 | 0.65 |
| 8 | 0.9998 |
| 16 | 0.99999 |
| 32 | 1 |
| 64 | 1 |
| 128 | 1 |

The cycle time determining function 30 may then estimate the control performance corresponding to cycle time and QoS of the relationship 32 based on the group of further mappings 34, 36, 38, 40, S220. The estimation of control performance may thus be based on the mapping of control performance to the cycle time and quality of service in the group of further mappings. Here it is possible that the estimates are based on a statistical operation of the control performances linked to the cycle times and QoS of the further mappings, such as determining a median or average value of the control performances corresponding to different cycle time. It is also possible that the worst case is removed. It is for instance possible to omit the fourth further mapping 40 from the operation as the type of communication network is wired, while the first wireless communication network 18 is wireless. It is also possible to omit a further mapping based on a lack of resemblance to the relationship 32. As another option, it is possible that the control performance of the same type of communication network is estimated to be the control performance of the first wireless communication network 18. If for instance the first wireless communication network 18 is a 5G network, it is possible that the control performances of the first further mapping 34 are estimated to be the control performances corresponding to the relationship 32. As another possibility it is possible to take the control performances of the further mapping having a relationship between QoS and cycle time that most resembles the relationship 32 to be the estimated control performances.

After the control performances corresponding to the relationship 32 have been estimated, they are then added to the relationship 32 in order to form the first mapping 31, S230.

After the control performances have been added to the relationship 32 for forming the first mapping 31, the cycle time determining function 30 then analyses the first mapping 31, S240, and thereafter determines a cycle time based on the analysis, S250, which may be done in the same way as in the first variation. It is additionally possible that a QoS is negotiated with the network management system 20 corresponding to the determined cycle time, S260, which may also be done in the same way as in the first variation of the method.

The above-mentioned steps S200-S250 can be summarized in the following way.

For each line of Table II, the cycle time determining function 30 looks into Table I and performs the best estimation of control performance it can make based on the empirical data of the known communication networks. As an example, a curve of the estimated control performance as a function of the cycle time of the first mapping M1 31 is plotted in FIG. 9. As a comparison, curves of the control performance as a function of cycle time for the first, second, third and fourth further mappings FM1 34, FM2 36, FM3 38, FM4 40 are also shown. From the curve corresponding to the first mapping 31, the cycle time determining function 30 can find an optimal cycle time, which in this example is 8 ms. The optimal cycle time may correspond to the minimum of the control performance, when the control performance is expressed as an error such as the Relative Root Mean Square Error of Motor Speed. It should also be realized that for another control performance that is not an error, then the optimal cycle time may correspond to the maximum of the control performance.

It can in this way be seen that a cycle time is determined that considers both QoS and control performance. The cycle time is thus not only determined based on the needs of the process control function but also based on the limitations of wireless communication network being used. Thereby it is possible to achieve a better control performance without changing the wireless communication network itself.

In the example given above, the control performance was indicated by the Relative Root Mean Square Error of Motor Speed. It should be realized that the control performance can be indicated by other parameters, such as parameters that are linked to the performance in communicating between the process control function and the first automation device like average latency, reliability, packet loss rate, etc. However, it is also possible with other types of parameters linked to the control, such as stability, convergence speed, energy consumption, etc., depending on the application.

Furthermore, a motor is merely one example of an automation device. The first automation device 22A can be any type of device that is used in process control systems such as a robot, a relay, a valve, a power switch, a conveyer belt, a motor, a drive, an I/O module, and any type of sensor or actuator.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

1. A cycle time determining device for determining a cycle time of a process control system, the process control system comprising an automation device, a process control function and hardware; implementing the process control function, where the process control function controls the automation device in a process control loop via a first wireless communication network;
the cycle time determining device including a cycle time determining function and hardware implementing the cycle time determining function, the cycle time determining function being configured to: obtain a first mapping of cycle time of the process control loop to quality of service of the first wireless communication network and control performance of the process control loop;
analyse the first mapping between cycle time, quality of service and control performance; and
determine a cycle time to be used in the first wireless communication network based on the analysis
wherein the cycle time determining function is further configured to obtain at least one further mapping between cycle time, control performance and quality of service of at least one other communication network and where the obtaining of the first mapping includes obtaining a relationship between cycle time and quality of service of the first wireless communication network and adding estimates of control performance to said relationship between cycle time and quality of service for forming the first mapping where the estimates of control performance are based on the mapping of control performance to the cycle time and quality of service in the at least one further mapping.

2. The cycle time determining device according to claim 1, wherein the determined cycle time is a cycle time for which the combination of cycle time, quality of service and control performance fulfils a control loop criterion.

3. The cycle time determining device according to claim 2, wherein the control loop criterion is that the combination is optimal.

4. (canceled)

5. (canceled)

6. The cycle time determining device according to claim 1, wherein the at least one further mapping comprises a group of further mappings, where the mappings are mappings of cycle time and control performance to quality of service of different types of communication networks.

7. The cycle time determining device according to claim 1, wherein the control performance comprises a performance of the automation device.

8. The cycle time determining device according to claim 1, wherein the control performance comprises a performance of communication between the process control function and the automation device.

9. A method of determining a cycle time to be used in a process control system, the process control system comprising
a process control function and hardware implementing the process control function, where the process control function controls an automation device in a process control loop via a first wireless communication network;
the method being performed by a cycle time determining function and comprising:
obtaining a first mapping of cycle time of the process control loop to quality of service of the first wireless communication network and control performance of the process control loop;
analysing the first mapping between cycle time, quality of service and control performance; and
determining a cycle time to be used in the first wireless communication network based on the analysis
the method further including obtaining (S200) at least one further mapping (34, 36, 38, 40) between cycle time, control performance and quality of service of at least one other communication network and where the obtaining of the first mapping includes obtaining (S210) a relationship (32) between cycle time and quality of service of the first wireless communication network (18) and adding (S230) estimates of control performance to said relationship (32) between cycle time and quality of service for forming the first mapping (31), where the estimates of control performance have been estimated (S220) based on the mapping of control performance to the cycle time and quality of service in the at least one further mapping (32, 36, 38, 40).

10. (canceled)

11. (canceled)

12. The method according to claim 9, further comprising negotiating a quality of service with a network management system of the first wireless communication network, which negotiated quality of service corresponds to the determined cycle time.

13. A process control system comprising:
an automation device;
a process control function and hardware implementing the process control function, where the process control function controls the automation device in a process control loop via a first wireless communication network; and
a cycle time determining function and hardware implementing the cycle time determining function, the cycle time determining function being configured to obtain a first mapping of cycle time of the process control loop to quality of service of the first wireless communication network and control performance of the process control loop, analyse the first mapping between cycle time, quality of service and control performance and determine a cycle time to be used in the first wireless communication network (8) based on the analysis.

14. A computer program for determining a cycle time to be used in a process control system,
the process control system comprising a process control function and hardware implementing the process control function, where the process control function controls an automation device in a process control loop via a first wireless communication network, the computer program comprising computer program code which when run by a processor implements a cycle time determining function configured to:
obtain a first mapping of cycle time of the process control loop to quality of service of the first wireless communication network and control performance of the process control loop;
analyse the first mapping between cycle time, quality of service and control performance; and
determine a cycle time to be used in the first wireless communication network based on the analysis
wherein the cycle time determining function is further configured to obtain at least one further mapping between cycle time, control performance and quality of service of at least one other communication network and where the obtaining of the first mapping includes obtaining a relationship between cycle time and quality of service of the first wireless communication network and adding estimates of control performance to said relationship between cycle time and quality of service for forming the first mapping, where the estimates of control performance are based on the mapping of control performance to the cycle time and quality of service in the at least one further mapping.

15. A computer program product for determining a cycle time to be used in a process control system, the computer program product comprising a data carrier with the computer program code having a process control system including a process control function and hardware implementing the process control function, where the process control function controls an automation device in a process control loop via a first wireless communication network, the computer program comprising computer program code which when run by a processor implements a cycle time determining function configured to:
obtain a first mapping of cycle time of the process control loop to quality of service of the first wireless communication network and control performance of the process control loop;
analyse the first mapping between cycle time, quality of service and control performance; and
determine a cycle time to be used in the first wireless communication network based on the analysis
wherein the cycle time determining function is further configured to obtain at least one further mapping between cycle time, control performance and quality of service of at least one other communication network and where the obtaining of the first mapping includes obtaining a relationship between cycle time and quality of service of the first wireless communication network and adding estimates of control performance to said relationship between cycle time and quality of service for forming the first mapping, where the estimates of control performance are based on the mapping of control performance to the cycle time and quality of service in the at least one further mapping.

16. The cycle time determining device according to claim 2, wherein the control performance comprises a performance of the automation device.

17. The cycle time determining device according to claim 2, wherein the control performance comprises a performance of communication between the process control function and the automation device.
